(19) United States
(12) Patent Application Publication
(10) Pub. No.: US 2010/0245118 A1
(43) Pub. Date: Sep. 30, 2010

(54) MULTIMODAL FUSION APPARATUS CAPABLE OF REMOTELY CONTROLLING ELECTRONIC DEVICES AND METHOD THEREOF

(75) Inventors: Dong Woo Lee, Daejeon (KR); Il Yeon Cho, Daejeon (KR); Ga Gue Kim, Daejeon (KR); Ji Eun Kim, Daejeon (KR); Jeong Mook Lim, Daejeon (KR); John Sunwoo, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, Daejeon (KR)

(21) Appl. No.: 12/739,884

(22) PCT Filed: Jul. 8, 2008
(86) PCT No.: PCT/KR2008/004007

§ 371 Date: Apr. 26, 2010

(30) Foreign Application Priority Data
Dec. 15, 2007 (KR) 10-2007-0131826

(51) Int. Cl. G08C 19/00

(52) U.S. Cl. 340/825.69

(57) ABSTRACT

There are provided a multimodal fusion apparatus capable of remotely controlling a number of electronic devices and a method for remotely controlling a number of electronic devices in the multimodal fusion apparatus. In accordance with the present invention, instead of one input device, such as a remote control or the like, multimodal commands, such as user-familiar voice, gesture and the like, are used to remotely control a number of electronic devices equipped at home or within a specific space. That is, diverse electronic devices are controlled in the same manner by the multimodal commands. When a new electronic device is added, control commands thereof are automatically configured to control the new electronic device.

### CROSS-REFERENCE(S) TO RELATED APPLICATIONS

The present invention claims priority of Korean Patent Application No. 10-2007-0131826, filed on Dec. 15, 2007, which is incorporated herein by reference.

### TECHNICAL FIELD

The present invention relates to a multimodal system and, more particularly, to a multimodal fusion apparatus capable of remotely controlling a number of electronic devices by multimodal commands, such as user-familiar voice, gesture and the like, and a method thereof.

This work was supported by the IT R&D program of MIC/IITA. [2005-S-065-03, Development of Wearable Personal Station]

### BACKGROUND ART

In general, a “multimodal” means several modalities and a modality means a sense channel, such as each of vision modality, audition modality, haptic modality, gustation modality, olfaction modality, and the like. Technologies have presented multimodal processing apparatuses or the like, which recognize input information from a user, by recognizing user-friendly manners.

A multimodal processing apparatus recognizes a user's voice and the like as well as the user's direct touch input using a key panel, receives key input and performs the relevant operation accordingly. The multimodal processing apparatus is considered as the technology to be valuably used in controlling diverse electronic devices.

Remote controls are used to transfer user input to diverse electronic devices at home. Each electronic device has a remote control which transfers the user's input to the relevant electronic device, by the most general IrDA standard.

As the number of electronic devices at home has increased, many companies including Universal Remote Console (URC) Consortium have developed a remote control capable of controlling different electronic devices in an integrated manner. When it is assumed that much more home electronic devices are provided in the coming ubiquitous environment, the demand for controlling the home electronic devices through a user-friendly interface by using a single device is expected to increase.

If the aforementioned multimodal processing apparatus realizes the function of a remote control capable of controlling a number of home electronic devices in the integrated manner as the single device to control the home electronic devices and to provide the user-friendly interface, it is expected to provide the user-friendly interface and to efficiently control a number of electronic devices at home.

Furthermore, in case a new electronic device to be controlled by the multimodal processing apparatus is added, the multimodal processing apparatus needs to have the function of automatically configuring control commands to dynamically control the relevant new electronic device, through communication with the relevant new electronic device.

### DISCLOSURE OF INVENTION

### Technical Problem

It is, therefore, an object of the present invention to provide a multimodal fusion apparatus capable of remotely controlling a number of electronic devices by multimodal commands, such as user-familiar voice, gesture and the like, and a method thereof.

### Technical Solution

In accordance with a preferred embodiment of the present invention, there is provided a multimodal fusion apparatus for remotely controlling a number of electronic devices including: an input processing unit for recognizing multimodal commands of a user and processing the multimodal commands as inferable input information; a rule storing unit for storing control commands for each electronic device, to remotely control a number of electronic devices; a device selecting unit for selecting the electronic device to be controlled and transmitting remote control commands to the selected electronic device; a control command receiving unit for receiving the control commands from the electronic device; and a multimodal control unit for remotely controlling the selected electronic device in response to the multimodal commands of the user, by reading the control commands of the relevant electronic device selected to be controlled, from the rule storing unit.

Further, in accordance with a preferred embodiment of the present invention, there is provided a method for remotely controlling a number of electronic devices in a multimodal fusion apparatus, including: transmitting an ID of the multimodal fusion apparatus and a request for remote control to an electronic device selected to be controlled; forming a communication channel for remote control with the electronic device responding to the request for remote control; and remotely controlling the relevant electronic device in response to multimodal commands of a user, by reading control commands of the electronic device.

### ADVANTAGEOUS EFFECTS

In accordance with the present invention, a number of different electronic devices provided at home or within a specific space are remotely controlled, in the same manner, by using multimodal commands, such as user-familiar voice, gesture and the like, not by using an individual input device, such as a remote control. Furthermore, when a new electronic device is added, the control commands to control the new electronic device are automatically configured so that the new electronic device is also controlled. Therefore, the convenience in use significantly increases.

### BRIEF DESCRIPTION OF THE DRAWINGS

The above and other objects and features of the present invention will become apparent from the following description of preferred embodiments given in conjunction with the accompanying drawings, in which:

FIG. 1 is a specific block diagram of a multimodal fusion apparatus according to an embodiment of the present invention;

FIGS. 2 and 3 are views of examples of an ActionXML format administered by a user system and an electronic device system according to the embodiment of the present invention; and

FIG. 4 is a flow chart of a process of remotely controlling the operation of a number of electronic devices, in response to multimodal commands of the multimodal fusion apparatus according to the embodiment of the present invention.

### MODE FOR THE INVENTION

Hereinafter, preferred embodiments of the present invention will be described in detail with reference to the accompanying drawings so that they can be readily implemented by those skilled in the art. Where the function and constitution are well-known in the relevant arts, further discussion will not be presented in the detailed description of the present invention in order not to unnecessarily make the gist of the present invention unclear. The terms or words used hereinafter should be interpreted as having a meaning that is consistent with their meaning in the context of the relevant art and the technical idea of the invention, considering the function of the invention. Therefore, the terms or words may vary according to the intention or practice of a user/an operator. Therefore, the definitions of the terms and words may be made based on the disclosure of the detailed description.

The specific core gist of the technique of the present invention is that, instead of an individual input device, such as a remote control, the multimodal commands, such as user-familiar voice, gesture and the like, are used to remotely control a number of different electronic devices, and when a new electronic device is added, control commands are automatically configured to control the new electronic device. Therefore, the above and other objects are accomplished by the technique of the present invention.

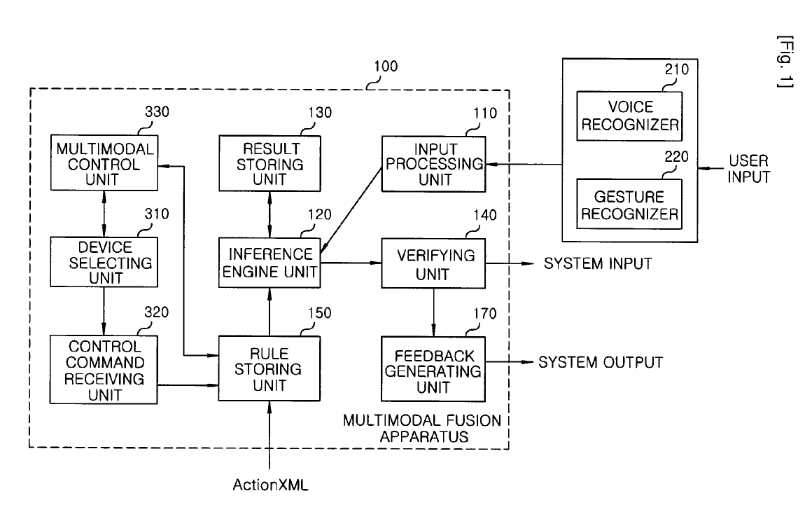

FIG. 1 is a specific block diagram of a multimodal fusion apparatus 100 which is capable of remotely controlling a number of electronic devices by user-friendly multimodal commands, according to an embodiment of the present

With reference to FIG. 1, the multimodal fusion apparatus 100 comprises a device selecting unit 310 and a control command receiving unit 320. The device selecting unit 310 selects one from a number of electronic devices and enables the control commands to be transmitted to the selected electronic from the relevant electronic device. The multimodal fusion apparatus 100 extends ActionXML to dynamically re-configure the control commands of the electronic device to be controlled.

That is, as shown in [Table 1], a device element of ActionXML is added, thereby enabling to administer the control commands for each electric device. Each electric device has its control commands in the ActionXML format and transmits the control commands when a request thereof is made from the multimodal fusion apparatus 100.

TABLE 1

| Element | Explanation | Remark |
|---|---|---|
| adxml | ActionXML element | |
| action | most significant element defining one | Child element |
| | action | input, |
| | | integration |
| input | element listing modalities to be input | Child element |
| | in the relevant actions | command |
| inte- | element presenting significant | Child element |
| gration | combination methods of input modalities | or, and |
| | listed in the input, for the relevant | |
| | action | |
| command | child element of the input, listing | Child element |
| | commands of the relevant modality | item |
| item | modality command list | |
| or | child element of the integration | Child element |
| | element, being used to indicate the | modality, or, |
| | rules of the modality combinations and | and |
| | indicating that satisfying only one | |
| | requirement of the child elements will | |
| | be enough | |
| and | child element of the integration | Child element |
| | element, being used to indicate the | modality, or, |
| | rules of the modality combinations and | and |
| | indicating that all of the child | |
| | elements should be satisfied | |
| modality | element designating one of the | |
| | commands of the input element | |
| set | element to combine a number of actions | Child element |
| | according to the properties of the | sequence, time |
| | action element, having the sequence | |
| | element as the child elements | |
| sequence | child element of the set element, | Child element |
| | defining the sequence of the action | actionname |
| | being input by a user, according to the | |
| | properties of the action element | |
| time | child element of the set element, | |
| | which is significant maximum input time | |
| | of the actions listed under the set | |
| | element | |
| action- | child element of the sequence element, | |
| name | indicating each action | |

As shown in [Table 1], the ActionXML defines and includes the elements, such as “adxml, action, input, integration, command, item, or, and, modality, set, sequence, time, and actionname”, and the device element is added according to the present invention. When “Action” is the final control command of the electric device to be controlled, all “actions” of controlling the device are defined in the child elements of the device element.

[Table 2] illustrates the DTD (document type definition) of modified ActionXML, and [Table 3] illustrates an example of defining the “action” of a television as an electronic device, using ActionXML.

TABLE 2

<?xml version=“1.0” ?>
<!DOCTYPE adxml [
<!ELEMENT device (action)*>
<!ELEMENT action (input?, integration)>
<!ELEMENT input (modality)+ >
<!ELEMENT modality (command)+ >
<!ELEMENT command (#PCDATA) >
<!ELEMENT integration ((or*|and*)|set*)+>
<!ELEMENT or (modname*|or*|and*)+>
<!ELEMENT and (modname*|or*|and*)+>
<!ELEMENT modname EMPTY>
<!ELEMENT set sequence+>
<!ELEMENT sequence actionname*>
<!ATTLIST device id ID #REQUIRED>
<!ATTLIST device name CDATA #REQUIRED>
<!ATTLIST device model CDATA #IMPLIED>
<!ATTLIST device url CDATA #IMPLIED>
<!ATTLIST action name ID #REQUIRED>
<!ATTLIST action type (multi|single) “single”>
<!ATTLIST modality mode CDATA #REQUIRED>
<!ATTLIST modality name CDATA #REQUIRED>
<!ATTLIST or weight CDATA #IMPLIED >
<!ATTLIST and weight CDATA #IMPLIED >
<!ATTLIST modname weight CDATA #IMPLIED >
<!ATTLIST modname value CDATA #REQUIRED>
<!ATTLIST sequence value CDATA #REQUIRED>
]>

```
TABLE 3
<?xml version=“1.0” encoding=“ksc5601”?>
<adxml version=“1.0”>
<device  id=”0A:0B:0C:0D:0E:0F”  model=”SS501TV”
name=”TV” url=”http://www.device.com/tv/ss501tv.xml”>
    <action name=“CHANNELUP” type=“single”>
        <input>
            <modality mode=“voice” name=“voice1”>
                <command>channel up</command>
            </modality>
            <modality mode=“voice” name=“voice2”>
                <command>channel</command>
            </modality>
            <modality mode=“gesture” name=“gesture1”>
                <command>Up</command>
                <command>Right</command>
            </modality>
        </input>
        <integration>
            <or>
                <modname weight=“1.0” value=“voice1”/>
                <and weight=“1.0”>
                    <modname value=“voice1”/>
                    <modname value=“gesture1”/>
                </and>
                <and weight=“0.8”>
                    <modname value=“voice2”/>
                    <modname value=“gesture1”/>
                </and>
            </or>
        </integration>
    </action>
    <action name=”CHANNELDOWN” type=”single”>
    ....
    </action>
    <action name=”VOLUMEUP” type=”single”>
    ....
    </action>
    <action name=”VOLUMEDOWN” type=”single”>
    ....
    </action>
</device>
</adxml>
```

In the multimodal fusion apparatus 100, when recognition information corresponding to the input of user multimodalities, such as voice, gesture and the like, is input from recognizers 210 and 220, an input processing unit 110 processes the recognition information as modality input information including a modality start event, an input end event and a result value event, and outputs the modality input information to an inference engine unit 120.

The inference engine unit 120 sequentially determines whether the modality input information can be combined and whether the modality input information needs to be combined, referring to modality combination rule information of a rule storing unit 150. That is, the inference engine unit 120 determines whether single or diverse user input can be inferred with respect to the action according to the modality combination rule and whether the user input needs the action inference.

When it is determined that the modality input information can be combined and needs to be combined, the inference engine unit 120 infers a new action, referring to the modality combination rule information of the rule storing unit 150 and the existing action information of a result storing unit 130. However, when it is determined that the modality input information cannot be combined or does not need to be combined, the inference engine unit 120 stops its operation, without inferring the action, until new modality input information is input.

When a new action is input from the inference engine unit 120, a verification unit 140 performs verification of the action being input. As a result of the verification, when it is determined that the action is not proper or when an error occurs during the verification, the verification unit 140 outputs action error information to a feedback generating unit 170. As a result of the verification, when it is determined that the action is proper, the verification unit 140 transmits the relevant action to a system input.

When the action error information is input from the verification unit 140, the feedback generating unit 170 defines the action error information in such a way of informing a user thereof and transfers the action error information to a system output so that the user confirms that the user input has a problem.

To remotely control a number of electronic devices, the rule storing unit 150 stores the control commands for each electronic device as the modality combination rule information defined in the ActionXML format and provides the control commands of the electronic device to be selected to be controlled, according to the control of a multimodal control unit 330.

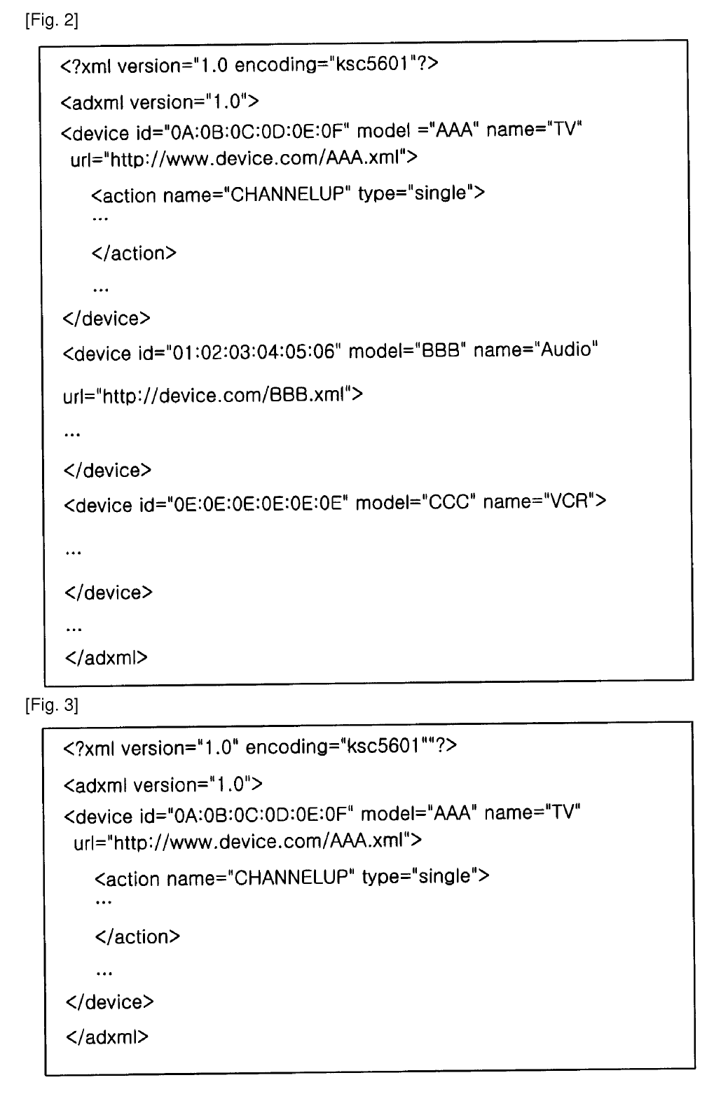

FIGS. 2 and 3 are views of the ActionXML format administered by the multimodal fusion apparatus 100 and the electronic device system to be remotely controlled.

As illustrated in FIG. 2, the multimodal fusion apparatus 100 comprises a number of device elements and is configured to add a device element by receiving the control commands from the relevant electronic device. However, as illustrated in FIG. 3, the electronic device has one device element and lists the multimodal control commands of the relevant electronic device.

The device selecting unit 310 comprises a directional communication unit, such as infrared rays, laser beams or the like, thereby transmitting an ID (IP or MAC address information) of the multimodal fusion apparatus to the electronic device selected to be controlled by a user and waiting for a response. Then, the electronic device receiving a request for remote control from the device selecting unit 310 confirms the ID of the relevant multimodal fusion apparatus and responds, using a non-directional communication unit, such as WLAN, Zigbee, Bluetooth or the like. Accordingly, the device selecting unit 310 receives the response from the electronic device through the non-directional communication unit and forms a communication channel, thereby transmitting the control commands through the formed channel.

When the rule storing unit 150 has no control commands of the electronic device selected to be controlled, the control command receiving unit 320 receives the control commands stored within the relevant electronic device. However, when no control commands are stored in the relevant electronic device, the control command receiving unit 320 receives url information storing the control commands from the electronic device and downloads the control command through the network.

The multimodal control unit 330 reads the control commands of the electronic device selected to be controlled, from the rule storing unit 150, and remotely controls the relevant electronic device in response to the multimodal control commands of a user. When the request for remote control is made through the device selecting unit 310 and two or more electronic devices respond, the multimodal control unit 330 displays the information of the relevant electronic devices and selects one electronic device to be controlled, according to the selection of the user.

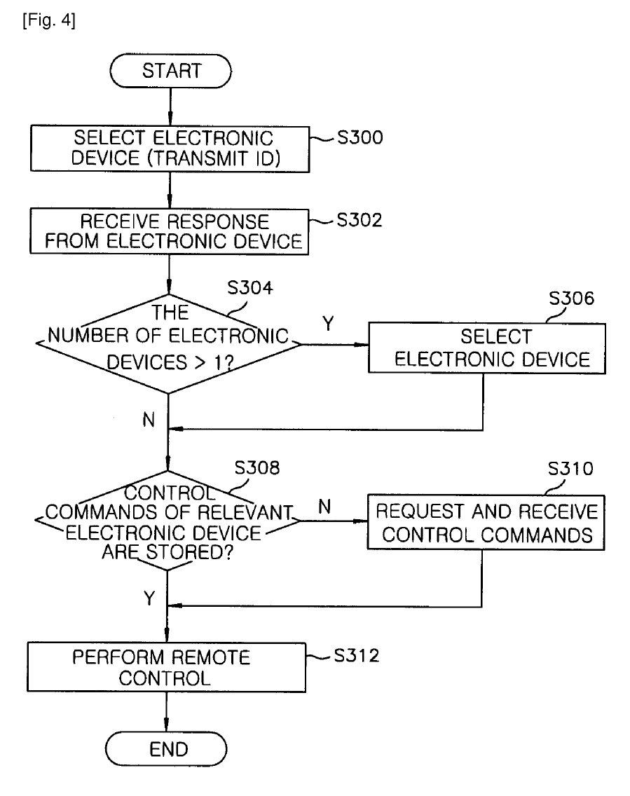

FIG. 4 is a flow chart of a process of remotely controlling the operation of a number of electronic devices in response to the multimodal commands of a user, in the multimodal fusion apparatus capable of remotely controlling a number of electronic devices according to the embodiment of the present invention. The embodiment of the present invention will be described, in detail, with reference to FIGS. 1 and 4.

At step 300, when the function of remotely controlling a number of electronic devices is selected according to the present invention, the multimodal control unit 330 transmits the ID of the multimodal fusion apparatus 100 and a request for remote control to an electronic device being selected to be controlled through the device selecting unit 310.

Then, at step S302, the device selecting unit 310 comprises a directional communication unit, such as infrared rays, laser beams or the like, and transmits the ID of the multimodal fusion apparatus 100 to the electronic device selected to be controlled by a user, through the direction communication unit. The relevant electronic device receiving the request for remote control from the device selecting unit 310 confirms the ID of the multimodal fusion apparatus 100 and responds by using the non-directional communication unit, such as WLAN, Zigbee, Bluetooth or the like.

When an electronic device is selected through the device selecting unit 310, even though the electronic device to be remotely controlled is selected through the directional communication unit, such as infrared rays, laser beams or the like, the other adjacent electronic devices may be selected simultaneously and thus two or more electronic devices may respond.

Therefore, at step S304, the multimodal control unit 330 checks whether the response is received from two or more electronic devices. When two or more electronic devices respond, at step S306, electronic device information, such as electronic device ID, electronic device name, model name and the like, being received from the relevant electronic device, are displayed so that one electronic device to be controlled is selected by the user.

When the electronic device to be controlled is decided, at step S308, the multimodal control unit 330 checks whether the control commands of the relevant electronic device are stored in the rule storing unit 150. When the control commands of the relevant electronic device do not exist in the rule storing unit 150, at step S310 the control commands are received from the relevant electronic device through the control command receiving unit 320. Then, when the relevant electronic device does not have the control commands for reasons such as memory cost saving and the like, the control command receiving unit 320 may receive the url information storing the control commands from the relevant electronic device and download the control commands through the network.

When the control command receiving unit 320 receives the control commands of the electronic device to be controlled, at step S312, the multimodal control unit 330 remotely controls the relevant electronic device so that the electronic device responds to the multimodal control commands of the user by using the control commands.

While the invention has been shown and described with respect to the preferred embodiments, it will be understood by those skilled in the art that various changes and modifications may be made without departing from the spirit and scope of the invention as defined in the following claims.

1. A multimodal fusion apparatus for remotely controlling a number of electronic devices, comprising:
an input processing unit for recognizing multimodal commands of a user and processing the multimodal commands as inferable input information;
a rule storing unit for storing control commands for each electronic device, to remotely control a number of electronic devices;
a device selecting unit for selecting the electronic device to be controlled and transmitting remote control commands to the selected electronic device;
a control command receiving unit for receiving the control commands from the electronic device; and
a multimodal control unit for remotely controlling the selected electronic device in response to the multimodal commands of the user, by reading the control commands of the relevant electronic device selected to be controlled, from the rule storing unit.

2. The multimodal fusion apparatus of claim 1, wherein the rule storing unit stores the control commands for each electronic device as modality combination rule information defined in an ActionXML format and provides the control commands of the relevant electronic devices selected to be controlled.

3. The multimodal fusion apparatus of claim 1, wherein the device selecting unit forms a communication channel by transmitting an ID of the multimodal fusion apparatus to the electronic device selected to be controlled by the user, through a directional communication unit, and receiving a response from the electronic device, through a non-direction communication unit, and then transmits the remote control commands through the formed communication channel.

4. The multimodal fusion apparatus of claim 1, wherein, when the control commands are not stored within the electronic device, the control command receiving unit receives url information storing the control commands and downloads the control commands through a network.

5. The multimodal fusion apparatus of claim 3, wherein, when the communication channel with two or more electronic devices is formed through the device selecting unit, the multimodal control unit displays information of the relevant electronic devices so that one electronic device to be controlled is selected by the user.

6. The multimodal fusion apparatus of claim 3, wherein the ID of the multimodal fusion apparatus is IP information of the fusion apparatus or MAC address information.

7. A method for remotely controlling a number of electronic devices in a multimodal fusion apparatus, comprising:
transmitting an ID of the multimodal fusion apparatus and a request for remote control to an electronic device selected to be controlled;
forming a communication channel for remote control with the electronic device responding to the request for remote control; and
remotely controlling the relevant electronic device in response to multimodal commands of a user, by reading control commands of the electronic device.

8. The method of claim 7, wherein, the transmitting of the ID of the multimodal fusion apparatus and the request for remote control is performed through a directional communication unit using infrared rays or laser beams.

9. The method of claim 7, wherein the ID of the multimodal fusion apparatus is IP information of the multimodal fusion apparatus or MAC address information.

10. The method of claim 7, wherein, when two or more electronic devices respond to the request for remote control, the method further comprises:
displaying information of the relevant electronic devices; and
forming the communication channel with one electronic device being selected from the responding electronic device by the user.

11. The method of claim 7, wherein, the communication channel is formed through a non-direction communication unit including WLAN, Zigbee or Bluetooth.

12. The method of claim 7, wherein, the control commands of the electronic device is previously stored as modality combination rule information defined in an ActionXML format within the multimodal fusion apparatus.
